(19) United States
(12) Patent Application Publication
(10) Pub. No.: US 2025/0190657 A1
(43) Pub. Date: Jun. 12, 2025

(54) MULTI-LAYERED COLLABORATIVE FRAMEWORK COMPUTING APPARATUS AND ENGINEERING METHOD OF DESIGNING SAFETY CRITICAL SYSTEM USING MULTI-LAYERED FRAMEWORK

(71) Applicant: AJOU UNIVERSITY INDUSTRY-ACADEMIC COOPERATION FOUNDATION, Suwon-si (KR)

(72) Inventors: Seok-Won LEE, Suwon-si (KR); Sangeeta DEY, Chandannagar (IN)

(21) Appl. No.: 18/964,138

(22) Filed: Nov. 29, 2024

(30) Foreign Application Priority Data
Dec. 8, 2023 (KR) 10-2023-0177583
Apr. 5, 2024 (KR) 10-2024-0046937

(51) Int. Cl. G06F 30/27; G06F 111/10; G06F 119/02

(52) U.S. Cl. CPC G06F 30/27; G06F 2111/10; G06F 2119/02

(57) ABSTRACT

An embodiment relates to a design of a safety critical system, and more particularly, to a computing apparatus having a multi-layered framework including a problem layer, a data layer, and an evidence layer to provide guidance for a safety assurance process in designing a machine learning-based safety critical system, and a method of designing a safety critical system using the multi-layered framework.

### CROSS REFERENCE TO RELATED APPLICATION(S) OF THE DISCLOSURE

The present application claims the priority and benefit of Korean Patent Application No. 10-2023-0177583, filed on Dec. 8, 2023, and Korean Patent Application No. 10-2024-0046937, filed on Apr. 5, 2024, with the Korean Intellectual Property Office, the entire contents of which are incorporated herein by reference.

### BACKGROUND OF THE INVENTION

### Field of the Invention

The present disclosure relates to a design of a safety critical system, and more particularly, to a computing apparatus having a multi-layered framework capable of providing guidance for a safety assurance process in designing a machine learning-based safety critical system, and a method of designing a safety critical system using the multi-layered framework.

### Background of the Related Art

As artificial intelligence technology advances, data-centered machine learning (hereinafter referred to as ‘ML’) models are increasingly applied to various and complex computing apparatuses. For example, an obstacle detection function of an autonomous vehicle may be one of essential functions for ensuring safety in a safety critical system capable of being implemented using an ML model. However, due to various problems such as uncertainty of an ML model and incomplete requirements specifications, it may be difficult to ensure strict safety.

Particularly, in a case of ML model-based safety critical system engineering, although various developers focus on specifying ML-related performance requirements, there is such a problem that sufficient guidance for systematically engineering data requirements involving various stakeholders is not present.

Accordingly, there is a need to develop a framework capable of providing guidance for a safety assurance process by ensuring data quality through quantified uncertainty, belief, and plausibility in engineering a safety critical system based on an ML model.

### SUMMARY OF THE INVENTION

Therefore, the present disclosure has been made in view of the above problems, and it is an object of the present disclosure to provide a computing apparatus having a multi-layered framework capable of providing guidance for a safety assurance process by ensuring data quality through quantified uncertainty, belief, and plausibility in safety critical system engineering based on a machine learning (ML) model, and a method of designing a safety critical system using the multi-layered framework.

Particularly, a further object of the present disclosure is to provide a computing apparatus having a multi-layered framework capable of providing stage-specific guidance for a method of systematically recognizing, deriving, specifying, and ultimately validating data requirements based on an understanding of a problem domain in collaboration between various experts such as an ML componentlevel expert and a systemlevel expert, and a method of designing a safety critical system using the multi-layered framework.

However, objects of the present disclosure are not limited to the objects described above, and other objects may be understood based on the following description.

To accomplish the above object, according to one aspect of the present disclosure, there is provided a computing apparatus having a multi-layered framework configured to design a safety critical system using machine learning, the multi-layered framework including: a problem layer configured to produce a problem space exploration summary by defining an operational domain, safety critical goals and requirements, and risk factors for an operational environment to which the safety critical system is to be applied; a data layer configured to produce a data requirements specification by defining data requirements using the problem space exploration summary to minimize data uncertainty factors; and an evidence layer configured to produce a data uncertainty evaluation sheet corresponding to the defined data requirements using the problem space exploration summary and the data requirements specification.

The problem layer may include: an operational domain exploration module configured to define the operational domain for the operational environment to which the safety critical system is to be applied; a goals and requirements exploration module configured to define safety critical goals, calculate operational requirements from the defined safety critical goals, and define domain components; and a risk factor exploration module configured to produce the problem space exploration summary by defining risk factors including risks and hazards with respect to a problem domain.

The problem layer may be configured to: receive an input of at least one artifact among basic safety requirements, scenarios, a safety critical goal model, an operational design domain (ODD), domain-specific concept taxonomy, risk and hazard factors, and safety critical factors, and produce the problem space exploration summary including at least one item among basic safety requirements, relevant ODD factors, machine learning (ML) task-specific domain-concept definition, system-level risks associated with safety critical goals, and domain-specific risk factors.

The data uncertainty factors may include: a risk factor including at least one among a data collection error, a data preparation error, a representation gap, and an insufficient protection element against data corruption and capable of reducing reliability in training data and; and an insufficient mitigation plan element for domain-specific risks including at least one of demographic bias information and operational environment-related risk information.

Further, the data layer may include: a requirements derivation and analysis module configured to decompose a defined safety critical goal into sub-goals using the problem space exploration summary to minimize the data uncertainty factors, and define and produce data requirements according to the sub-goals obtained by decomposing; and a requirements specification module configured to produce the data requirements specification by defining evidence and acceptance criteria for the produced data requirements according to a predefined template and specifying a trace link for linking to the problem layer.

The defined template may include at least one indicator among a data requirement type, a data requirement identification (ID), a data requirement description, evidence, acceptance criteria, and a trace link.

In addition, the data layer may configured to: further receive an input of at least one artifact among the problem space exploration summary, data-type specific quality criteria, machine learning (ML) model-specific data quantity criteria, data type-specific risk factors, and domain-specific risk factors, and produce the data requirements specification including at least one item among data collection requirements, data annotation requirements, data representativeness requirements, trace links, and acceptable evidence to verify satisfaction of requirements.

The evidence layer may include: an evidence enhancement module configured to collect evidence input in correspondence with the defined data requirements using the problem space exploration summary and the data requirements specification, and label the collected evidence; and an evidence integration module configured to produce the data uncertainty evaluation sheet by calculating a belief mass for whether the labeled evidence is safe or unsafe according to an evidence theory to produce the data uncertainty evaluation sheet.

In addition, the evidence layer may be configured to: further receive an input of the problem space exploration summary and the data requirements specification, and an exploratory data analysis (EDA) summary; and produce the data uncertainty evaluation sheet including at least one item among data requirements, evidence and arguments evaluated according to the calculated belief mass, traceability, an uncertainty interval, and belief and plausibility.

To accomplish the above object, according to one aspect of the present disclosure, there is also provided a method of designing a safety critical system using a multi-layered framework included in a computing apparatus, the multi-layered framework being configured to design the safety critical system using machine learning and the method including: producing a problem space exploration summary by defining an operational domain, safety critical goals and requirements, and risk factors for an operational environment to which the safety critical system is to be applied; producing a data requirements specification by defining data requirements using the problem space exploration summary to minimize data uncertainty factors; and producing a data uncertainty evaluation sheet corresponding to the defined data requirements using the problem space exploration summary and the data requirements specification.

The producing of the problem space exploration summary may include: defining the operational domain for the operational environment to which the safety critical system is to be applied; defining safety critical goals, calculating operational requirements from the defined safety critical goals, and defining domain components; and producing the problem space exploration summary by defining risk factors including risks and hazards with respect to a problem domain.

In addition, the producing of the data requirements specification may include: decomposing the defined safety critical goals into sub-goals using the problem space exploration summary to minimize the data uncertainty factors, and defining and producing data requirements according to the sub-goals obtained by decomposing; and producing the data requirements specification by defining evidence and acceptance criteria for the produced data requirements according to a predefined template and specifying a trace link for linking to the problem layer.

In addition, the producing of the data uncertainty evaluation sheet includes: collecting evidence input in correspondence with the defined data requirements using the problem space exploration summary and the data requirements specification, and labeling the collected evidence; and producing the data uncertainty evaluation sheet by calculating a belief mass for whether the labeled evidence is safe or unsafe according to an evidence theory to produce the data uncertainty evaluation sheet.

Further, the present disclosure may provide a computer-readable recording medium having recorded thereon a program for executing the method described above.

According to a computing apparatus having a multi-layered framework and a method of designing a safety critical system using the multi-layered framework, data requirements that may be validated using a given template may be easily specified, and whether the data requirements are satisfied and an uncertainty inherent in training data may be quantified.

In addition, according to the present disclosure, presence of blind spots in training data may be easily detected through intellectual diversity (participation by various experts) and improved traceability (vertical and horizontal), thereby providing accurate guidance for a safety assurance process.

Further, various effects other than the effects described above may be directly or implicitly disclosed in the detailed description according to an embodiment of the present disclosure to be described later.

### BRIEF DESCRIPTION OF THE DRAWINGS

FIGS. 1 and 2 illustrate examples for explaining a problem space and a data space according to the present disclosure.

FIG. 3 is a configuration diagram illustrating a multi-layered framework applied to a multi-layered framework computing apparatus according to an embodiment of the present disclosure.

FIGS. 4 to 8 illustrate examples for explaining a multi-layered framework according to an embodiment of the present disclosure.

FIG. 9 illustrates a detailed example of the multi-layered framework according to an embodiment of the present disclosure.

### DETAILED DESCRIPTION OF THE PREFERRED EMBODIMENT

Features and advantages of the technical solution of the present disclosure and methods of accomplishing the same may be understood more readily with reference to the following detailed description of particular embodiments of the present disclosure and the accompanying drawings.

However, certain detailed explanations of well-known functions relevant to the present disclosure are omitted when it is deemed that they may unnecessarily obscure the essence of the present disclosure. In addition, it should be noted that like reference numerals in the drawings denote like elements, and thus their description will be omitted.

Hereinafter, terms or words used in this specification and claims should not be interpreted as being limited to have a general meaning or a meaning defined in a dictionary, but should be interpreted as having a meaning and a concept which are consistent with the technical ideas of the present disclosure, based on a principle such that an inventor may properly define concepts of the terms to explain the disclosure of the inventor by using an optimum method. Accordingly, it should be understood that embodiments in the specifications and configurations illustrated in drawings are only example embodiments of the present disclosure, and there is no intent to limit the example embodiments to the particular forms disclosed, but on the contrary, example embodiments are to cover all modifications, equivalents, and alternatives falling within the scope of the present disclosure.

Prior to description of a computing apparatus having a multi-layered framework according to an embodiment of the present disclosure and a method of designing a safety critical system using the multi-layered framework, the multi-layered framework computing apparatus according to an embodiment of the present disclosure may be applied to a safety critical system based on a machine learning (ML) model. The safety critical system is applied to such a system that a minute failure in the system may cause a fatal problem, and may be applied, for example, to a system having a function closely related to human life, like a pedestrian detection function of an autonomous vehicle.

In addition, description is provided on an assumption that the safety critical system according to an embodiment of the present disclosure is a system configured to operate by learning based on an ML model (e.g., traditional machine learning, deep learning, reinforcement learning, etc.). However, the safety critical system is not limited thereto, and may be applied to other equivalent artificial intelligence-based safety critical systems.

Hereinafter, embodiments of the present disclosure are described with reference to the drawings.

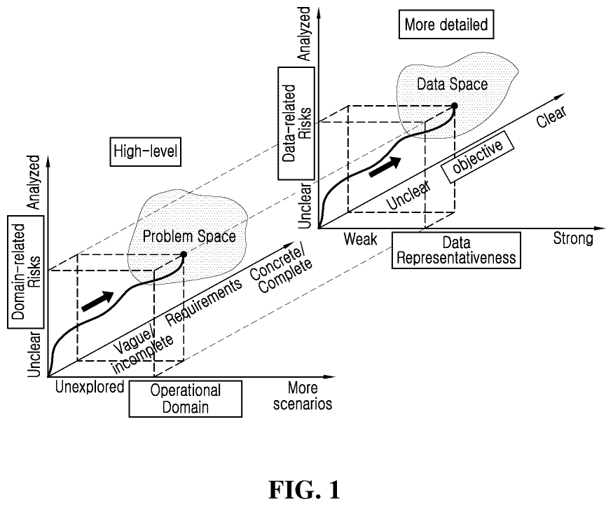

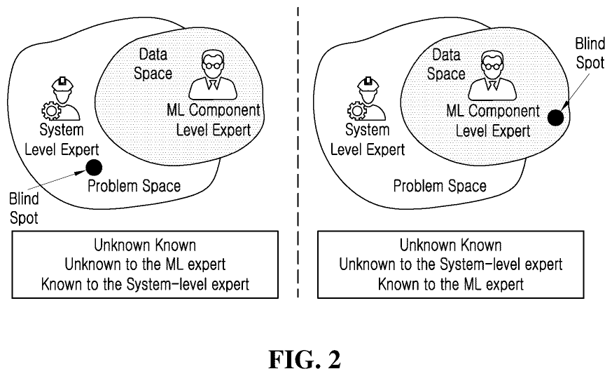

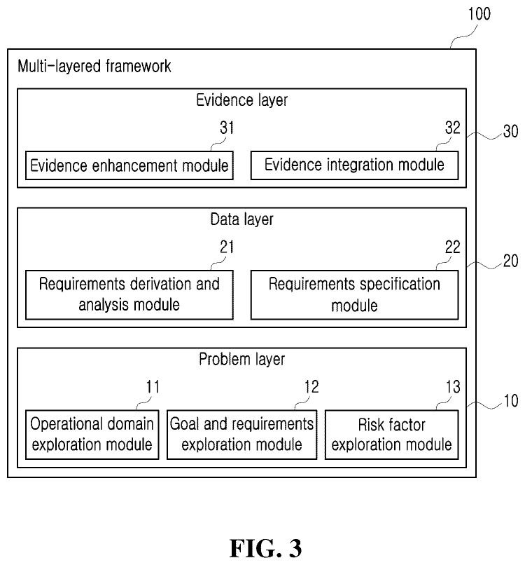

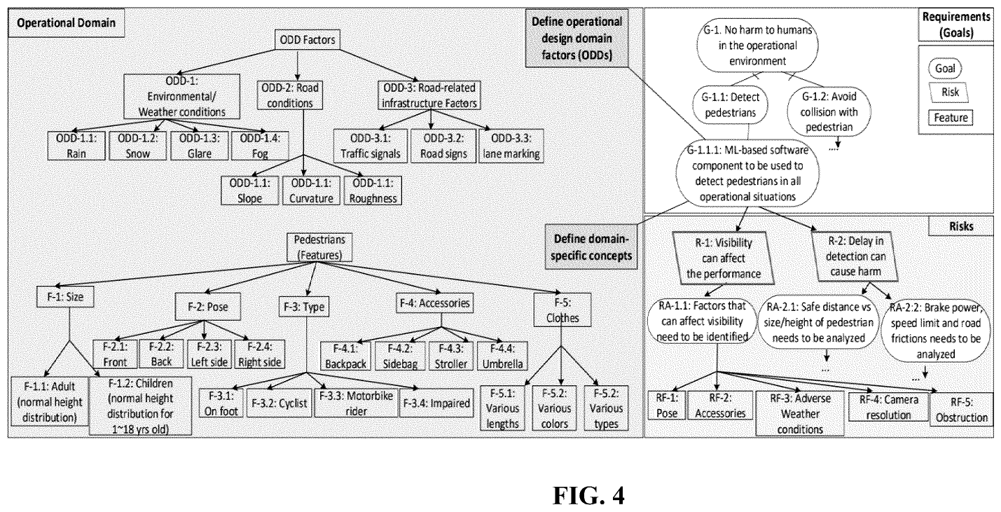

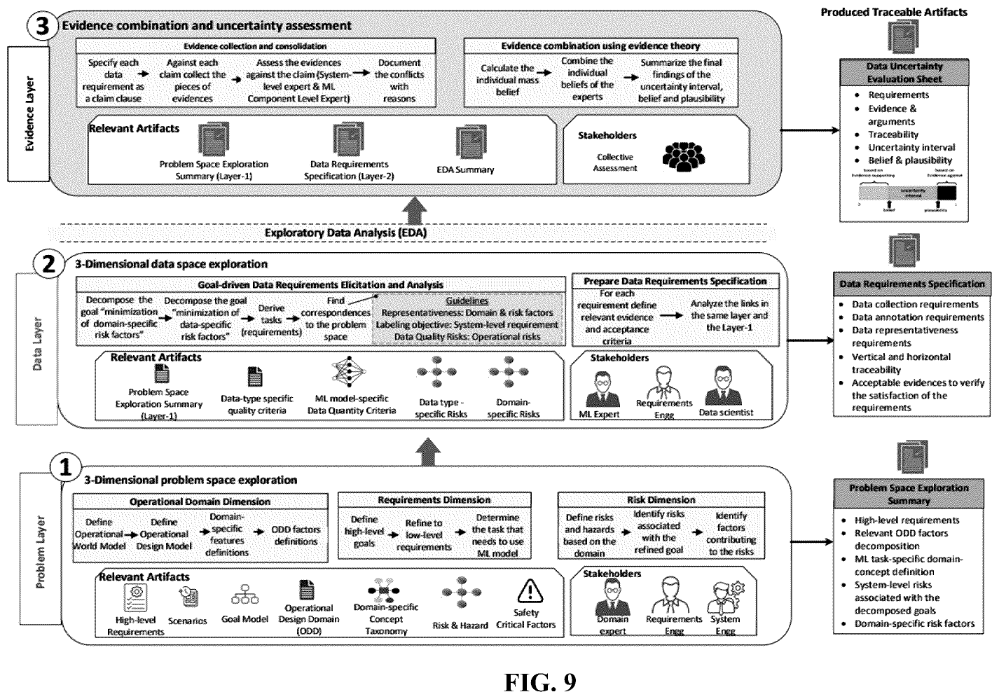

FIGS. 1 and 2 illustrate examples for explaining a problem space and a data space according to the present disclosure. FIG. 3 is a configuration diagram illustrating a multi-layered framework applied to a multi-layered framework computing apparatus according to an embodiment of the present disclosure. FIGS. 4 to 8 illustrate examples for explaining a multi-layered framework according to an embodiment of the present disclosure. In addition, FIG. 9 illustrates a detailed example of the multi-layered framework according to an embodiment of the present disclosure.

Referring to FIGS. 1 and 2, the problem space and the data space in the present disclosure are described. The problem space defined in the present disclosure may be defined as a three-dimensional space that involves variability in an operational domain, high-level system requirements, and associated risks. That is, the problem space indicates a problem that needs to be solved in terms of a whole system.

In addition, the data space is a part of a complex system and may mean training data for a particular machine learning (ML)-based component in charge of a particular function. For example, ensuring safety of pedestrians may be a high-level basic safety requirement goal of autonomous vehicles, while detection of pedestrians may be part of a decomposed (low-level) sub-goal implemented in the ML model.

As such, the problem space may be explored by understanding domain variability (operational domain dimension) and analyzing safety critical goals (requirement dimension) and associated risks (risk dimension).

The data space may be conceptualized as a three-dimensional space in which respective dimensions corresponds to the dimensions of the problem space. For example, data representativeness may explain suitability of data for representing domain diversity. To detect pedestrians, training data need to cover various types of pedestrians in all possible operating conditions (day and night, precipitation, etc.). Accordingly, the data representativeness need to ideally match the operational domain dimension of the problem space. Likewise, a goal of collecting and preparing for training data needs to comply with system-level requirements and constraints. This is a main collaboration point between a systemlevel expert and an ML component-level expert or a data level expert. When a systemlevel expectation is properly understood, correct context for ML training may be provided.

A method of collecting and preprocessing data may vary according to characteristics of a problem (classification, regression, etc.) from a perspective of ML.

In relation to the training data, two risks may be present. First, risks identified in the problem space (a corner case, a safety critical scenario, etc.) needs to be taken into account while preparing for the training data. Second, data based on learning data type and ML techniques may be vulnerable to data corruption, an incorrect collection method, etc. Such a correspondence between the two space dimensions may not only help to enhance traceability at a system level, but also ensure appropriateness of artifacts for determining an ML-based design as well as training data for safety critical ML-based functions.

In context of ML training, blind spots may be regarded as “unknown unknowns,” i.e., areas that are unknown as well as not fully identified. However, in context of RE and design context, the blind spots may be defined from a perspective of stakeholders participating in exploration of the problem space and the data space.

The systemlevel expert who knows a whole system may easily explore the problem space, and the ML componentlevel expert or the data level expert may easily explore the data space. Accordingly, since the two groups of experts work at different levels of abstraction, a knowledge gap may occur.

In consideration of this, in the present disclosure, the blind spots are defined as unknown knowns to explain a phenomenon that is unknown to a particular group of experts but known to other groups of experts.

That is, as illustrated in FIG. 2, the blind spots may vary depending on a perspective of experts. A blind spot from a perspective of the ML componentlevel expert is a spot in the problem space (a phenomenon about the system) which is known to the systemlevel expert but not to a data expert. For example, a domain expert may know an operational design domain that explicitly defines a precipitation range in which an autonomous vehicle needs to be capable of operating with a complete function, but the ML componentlevel expert or the data expert may not take into account an extreme precipitation range to be included in training data or needed to comprehensively augment data accordingly.

On the other hand, a blind spot from a perspective of the systemlevel expert may be a point in the data space (a phenomenon about the training data) which is known to the ML componentlevel expert. This may often happen in a case of genomic data on which the data expert performs exploratory data analysis, and then, discover a new data pattern. Such a result may not have been known to experts in a corresponding field.

A blind spot or unknown information may be very important, and particularly, to a safety critical system. Thus, the present disclosure proposes a comprehensive collaborative multi-layered framework that helps experts to identify missing requirements or discover a point helpful to update existing requirements.

In addition, in one embodiment of the present disclosure, a pedestrian detection function of an autonomous vehicle is to be mainly described. However, the present disclosure is not limited thereto, and may be applied to any function relevant to safety critical system engineering using machine learning.

Hereinafter, the multi-layered framework computing device according to an embodiment of the present disclosure is described with reference to FIG. 3.

The multi-layered framework computing device according to an embodiment of the present disclosure is configured to include a multi-layered framework 100 configured to design a safety critical system using machine learning. The multi-layered framework 100 may be configured to include a problem layer 10, a data layer 20, and an evidence layer 30.

The problem layer 10 extracts an operational domain, goals and requirements, and risk factors for an operational environment to which the safety critical system is to be applied, to derive a problem space exploration summary. The problem space exploration summary may be derived, as necessary information is input by a system engineer, a domain expert, and a requirements engineer. The problem layer 10 may adopt an available standard approach method, and receive an input of essential artifacts that function as an important baseline for deriving data requirements from the data layer 20, i.e., basic safety requirements which are high-level requirements, scenarios, a safety critical goal model, an operational design domain (ODD), domain-specific concept taxonomy, risk and hazard factors, and safety critical factors.

This problem layer 10 may be configured to include an operational domain exploration module 11, a goals and requirements exploration module 12, and a risk factor exploration module 13.

The operational domain exploration module 11 is configured for the system engineer and the domain expert to define an operational domain for the operational environment in which the safety critical system is to be applied. While the domain expert may provide a big picture of the operational domain, the system engineer may define a boundary within which the safety critical system is to be operated at a certain level of automation. Further, understanding a meaning of a domain-specific concept may be important for understanding a concept in general without a particular formal definition. Having a taxonomy of domain-related terms and corresponding properties for all domains may be very useful for design, verification, and validation.

The operational domain defined by the operational domain exploration module 11 may include an operational world model, an operational design model, domain-specific features definitions, and ODD factors definitions.

The goals and requirements exploration module 12 may define safety critical goals, derive operational requirements from the defined safety critical goals, and define domain components.

As an important activity when considering a complex system expected to include ML-based components, a need to use ML techniques for an ML development decision gate, i.e., a safety critical function may be evaluated. Accordingly, at this stage, it is important to decompose high-level safety critical goals and derive operational requirements therefrom, and a safety critical concept such as assured clear distance ahead (ACDA) may influence the preparation of an annotation protocol in the data layer 20.

In other words, a safety case approach method for validating all design selections in an engineering process needs to deal with several subjects including design domain definition, ML faults, etc. Accordingly, in the present disclosure, the defining of the domain components is prepared much earlier in the engineering process to evaluate a training data gap through data requirements in a next layer, i.e., the data layer 20.

As described above, the goals and requirements exploration module 12 may define the domain components such as defining high-level goals which are safety critical goals, refining to low-level requirements which may be operated from the defined safety critical goals, and determining a task that needs to use an ML model.

The risk factor exploration module 13 may perform a function along with a previous stage. The risk factor exploration module 13 formally defines and analyzes risk factors including risks and hazards with respect to a problem domain. For example, the risk factor exploration module 13 may analyze risks and hazards in safety requirements using a hazard analysis and risk assessment (HARA) technique, a failure mode and effect analysis (FMEA) technique, or a fault tree analysis (FTA) technique.

Risk factors that may be applied in context of safety critical functions such as detection of pedestrians may include, for example, driving environment factors such as lighting conditions, a road structure, obstacles, etc. In addition, disabled pedestrians (walking with canes, wheelchairs, etc.) or obstacles (obstructed view, dark clothing, etc.) may be risk factors needed for a design of a safety critical system.

As such, the problem layer 10 in the present disclosure uses essential artifacts to define an operational domain, goals and requirements, and risk factors for an operational environment where a safety critical system will be applied, and derives a problem space exploration summary through the defining. The derived problem space exploration summary may include at least one item among basic safety requirements which are high-level requirements, decomposition of relevant ODD factors, ML task-specific domain-concept definition, system-level risks associated with the decomposed goals, and domain-specific risk factors. An example of the problem space exploration summary is illustrated in FIG. 4.

The data layer 20 may function to derive a data requirements specification by defining the data requirements to minimize data uncertainty factors based on the problem space exploration summary derived through the problem layer 10.

In context of machine learning, data uncertainty may be generally measured using various statistical indices and considered inherently aleatoric (irreducible). However, from a perspective of an engineering process, data uncertainty may be caused by an epistemological aspect of a data engineering process. Lack of knowledge or ignorance may result in an improper designed training data collection and preparation processes. In the present disclosure, data uncertainty from a perspective of engineering may include a risk factor that may reduce reliability in training data and insufficient mitigation plans for domain-specific risks.

Reliability in the training data may be significantly reduced by uncertainties that occur due to ignorance or a failure of properly dealing with a next risk factor. Relevant risk factors may include, for example, a data collection error, a data preparation error, a representation gap, and insufficient protection against data corruption. In addition, insufficient mitigation plans for domain-specific risks, for example, demographic biases, operational environment-related risks, etc. may be included.

The data layer 20 derives data requirements helpful to minimize such data uncertainty. To do so, essential artifacts may include factors such as a problem space exploration summary derived from the problem layer 10, data-type specific quality criteria, ML model-specific data quantity criteria, data type-specific risks, and domain-specific risks. The essential artifacts may be input by an ML expert, a requirements engineer, and a data analyst.

In addition, the data layer 20 in the present disclosure is configured to include a requirements derivation and analysis module 21 and a requirements specification module 22.

The requirements derivation and analysis module 21 decomposes a goal into two basic goals: minimization of an impact of domain-specific risk factors and minimization of data-specific risk factors using a high-level goal-driven method to minimize the data uncertainty. As the domain-specific risk factors, operational environmental factors that may have a negative impact on pedestrian detection performance of the ML-based components. For example, identified risk factors illustrated in FIG. 4 need to be included in data.

When data collection for such scenarios cannot be performed due to domain/system-specific constraints, data needs to be comprehensively augmented and requirements for the data augmentation need to be specified. In other domains such as healthcare, demographic biases, gender biases, etc., need to be avoided, and accordingly, data should be curated.

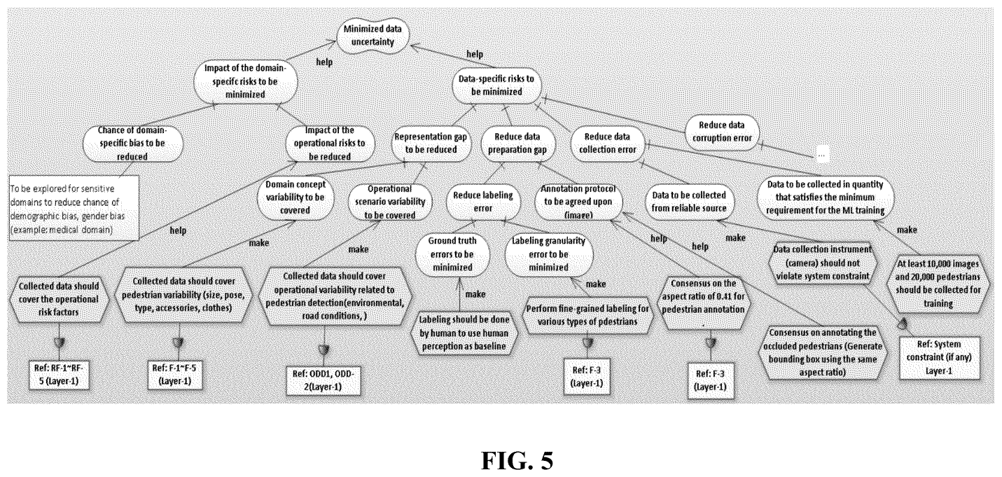

Likewise, in a case of data-related risks such as a representation gap, a preparation error, etc., a high-level goal may be decomposed to be linked to a traceable system-level concept. To minimize the data representation gap, the data needs to encompass ODD elements defined in the problem layer 10. All sub-goals may be decomposed until a task-specific description is achieved. FIG. 5 illustrates an example of a process of decomposition into sub-goals.

As such, the requirements derivation and analysis module 21 may perform decomposition into sub-goals to minimize the domain-specific risk factors and minimize the data-specific risk factors, and perform task derivation (data requirements) and find correspondences to a problem space. At this time, the finding of correspondences to the problem space may be performed according to guidelines for representativeness (domain and risk factors), labeling purposes (system-level requirements), and data quality risks (operational risks).

In addition, the requirements specification module 22 specifies data requirements. Based on work derived through the requirements derivation and analysis module 21, the requirements engineer defines relevant evidence and acceptance criteria for respective data requirements, and analyzes a trace link for linking between the data layer 20 and the problem layer 10.

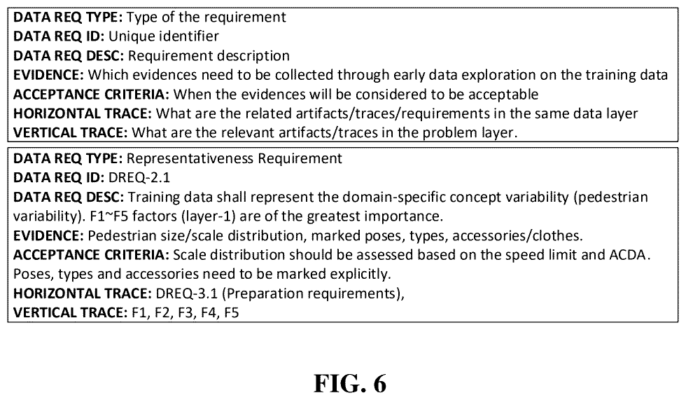

FIG. 6 illustrates an example of a template for specifying the data requirements. This may facilitate data quality assessment in the evidence layer 30. First, types of the data requirements are mentioned. In the present disclosure, four types of requirements including collection, representativeness, preparation, and annotation may be included.

Each of the data requirements may be identified by a unique identifier, and the data requirements need to be described in natural language that all experts involved in a process can understand. In addition, the template may include placeholders for evidence and corresponding acceptance criteria, where the evidence indicates the evidence that needs to be collected to verify satisfaction of the data requirements, and the corresponding acceptance criteria specify criteria for regarding the evidence as supportive evidence, respectively.

Last two places in the placeholders are intended to enhance traceability information. A horizontal trace is linked to a related concept or artifact in the data layer, whereas a vertical trace may provide a reference to a concept in a previous layer (a system level). For example, in a given example, requirements for data representativeness may have a horizontal trace to a related requirement, i.e., a preparation requirement, and may also include a vertical trace to an ODD element derived from the first layer, i.e., the problem layer 10.

As such, the data layer 20 in the present disclosure may further receive artifacts regarding the problem space exploration summary derived through the problem layer 10, data-type specific quality criteria, ML model-specific data quantity criteria, data type-specific risk factors, and domain-specific risk factors, and derive the data requirements specification including at least one item among data collection requirements, data annotation requirements, data representativeness requirements, trace links including vertical and horizontal traceability, and acceptable evidence to verify satisfaction of requirements through the requirements derivation and analysis module 21 and the requirements specification module 22 using the received artifacts.

The evidence layer 30 derives data requirements and collects training data, and then, collects evidence to evaluate a previous stage by using a result of exploratory data analysis (EDA) performed by the data expert on the collected training data. That is, the evidence layer 30 in the present disclosure receives, as artifacts, an input of a summary of the EDA together with the problem space exploration summary derived through the problem layer 10 and the data requirements specification derived through the data layer 20 to produce a data uncertainty evaluation sheet. In this case, the artifacts may be input through collective assessment by all the stakeholders.

At this time, the evidence layer 30 in the present disclosure may be configured to include an evidence enhancement module 31 and an evidence integration module 32.

The evidence enhancement module 31 may evaluate evidence from perspectives of the ML expert and the systemlevel expert based on a latest pedestrian detection technology and domain knowledge. Each piece of the collected evidence needs to be labeled as supportive, refuting, or insufficient evidence, and since a binary result of assessment of satisfaction of requirements may not be obtained at all times, a scope of the insufficient evidence needs to be maintained.

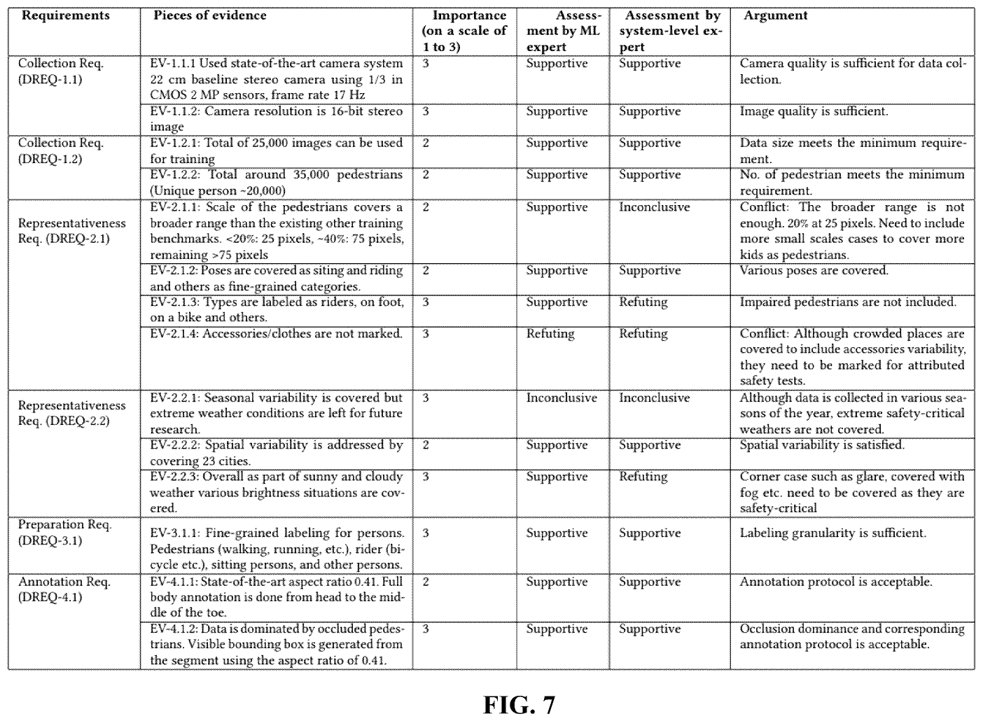

Therefore, epistemic uncertainty (lack of evidence) may also be taken into account in the evidence layer 30. FIG. 7 illustrates an example of data quality validation, i.e., evidence integration and evaluation for a dataset.

The evidence enhancement module 31 in the present disclosure may specify each data requirement as a clause of a claim, collect pieces of evidence against each claim, assess the pieces of evidence against the claim by the systemlevel expert and the ML componentlevel expert, and document conflicts with reasons.

The evidence integration module 32 performs the evidence integration according to an evidence theory obtained by modifying a Dempster-Shafer evidence theory according to an embodiment of the present disclosure. That is, the present disclosure is to calculate combined beliefs of experts on a hypothesis that “collected training data sufficiently satisfy data requirements to be used for training of a safety critical ML model.” Although individual beliefs may be directly calculated based on a number of pieces of supporting evidence, pieces of refuting evidence, and pieces of inconclusive evidence, a powerful mathematical theory that may combine various opinions by accommodating an epistemic uncertainty arising from conflicts among experts may be needed.

Accordingly, in the present disclosure, not only data uncertainty (a degree to which data satisfies requirements according to individual opinions) but also uncertainty of experts' opinions (a degree to which experts collectively believe quality of the data) may be calculated using the Dempster-Shafer evidence theory modified in the present disclosure. Here, unlike other probability theories in which knowledge of prior probability distributions is needed or a probability is assigned to only a single set at one time, a belief mass is assigned to proposition, a situation in which even experts have doubts about nature of a collected probability may be accommodated, evidence (inconclusive) may be present, and disagreement of opinions may be often present, according to the Dempster-Shafer evidence theory.

An identification frame for evaluating whether data is sufficiently safe or unsafe for safety critical ML training is shown in <Equation 1>.

$$Θ = Safe , Unsafe \qquad 〈 Equation 1 〉$$

In addition, a power set containing all possible subsets of Θ may be expressed as <Equation 2>.

$$P ( Θ ) = \{ ϕ , Safe , Unfsafe , ( Safe , Unsafe ) \} \qquad 〈 Equation 2 〉$$

In the present disclosure, the ML componentlevel expert and the systemlevel expert may be determined as main sources (hereinafter referred to as m1 and m2, respectively) of the belief mass.

Although only two types of experts are presented as examples due to simplicity and space constraints, belief structures of several experts may be combined with each other.

Since not all evidence is equally important, risk-related evidence can be given greater importance (on a scale of 1 to 3). First, a belief mass of an individual is calculated based on a weighted contribution of evidence according to Equation 3 shown below.

$$Individual Belief ( Safe ) = \frac{\sum Weights of the supportive evidence}{Total weight of all the evidence} \qquad 〈 Equation 3 〉$$

A belief mass of an individual with respect to being ‘unsafe’ and being ‘safe’ may be calculated by taking into account refuting evidence and inconclusive evidence, respectively.

$$Collective Belief ( Safe ) = {\sum }_{{A}_{1} ⋂ {A}_{2} = Safe} {m}_{1} ( {A}_{1} ) {m}_{2} ( {A}_{2} ) \qquad 〈 Equation 4 〉$$

In <Equation 4> presented above, a collective belief about a proposition of being ‘safe’ may not be a simple sum of belief masses in a single set of being ‘safe’. Instead, belief masses in another set having a common element (e.g., safe and unsafe) of being ‘safe’ may be included.

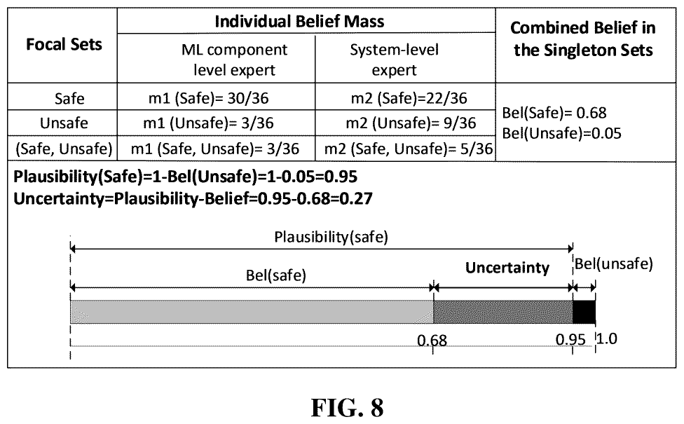

FIG. 8 shows that although most evidence is supportive, an uncertainty window widens to 0.27 due to lack of consensus among experts on refuting evidence and inconclusive evidence. This result may help to quantify subjective outcomes for assessing suitability of training data.

As such, the evidence layer 30 in the present disclosure receives an input of artifacts, and the input artifacts are produced as a data uncertainty evaluation sheet through the evidence enhancement module 31 and the evidence integration module 32. At this time, the data uncertainty evaluation sheet may include at least one item among data requirements, evidence and arguments evaluated according to a calculated belief mass, traceability, an uncertainty interval, and belief and plausibility.

The multi-layered framework according to an embodiment of the present disclosure has been described above. FIG. 9 illustrates a detailed example of the multi-layered framework in the present disclosure.

A method according to an embodiment of the present disclosure may not only ensure equal participation by relevant experts at each level, but also help to generate a written agreement that may be used as criteria for data quality validation.

In addition, the multi-layered framework in the present disclosure may facilitate generation of horizontal and vertical trace links. That is, generation of a horizontal and vertical trace link such as linking a problem space to a data space, ultimately, a data quality problem to evidence manipulation may be facilitated. Such a link may be further used to ensure safety to evaluate design decisions and rationales of the design decisions.

In addition, blind spots and missing requirements may be easily discovered. When several experts performs data quality validation, potential gaps in assumptions by the experts may be reduced.

In addition, according to the present disclosure, whether data requirements are met (or not) may be quantitatively evaluated based on judgment by the experts on evidence collected from a training data set. When an evidence theory newly defined by the present disclosure is used, an uncertainty inherent in training data may be quantified.

The multi-layered framework in the present disclosure may provide guidance for a safety assurance process capable of ensuring data quality through quantified uncertainty, belief, and plausibility, and also facilitate development of tool support automated for supporting stakeholders' processes.

The multi-layered framework computing apparatus according to an embodiment of the present disclosure has been described above.

The multi-layered framework computing apparatus according to an embodiment of the present disclosure may implement a method of designing a safety critical system using a multi-layered framework. The method of designing a safety critical system using a multi-layered framework may include: producing a problem space exploration summary by defining an operational domain, safety critical goals and requirements, and risk factors for an operational environment to which a safety critical system is to be applied; producing a data requirements specification by defining data requirements to minimize data uncertainty factors using the problem space exploration summary; and producing a data uncertainty evaluation sheet corresponding to the defined data requirements using the problem space exploration summary and the data requirements specification.

In addition, the method of designing a safety critical system using a multi-layered framework in the present disclosure as described above may be provided in a form of a computer-readable medium suitable for storing computer program instructions and data.

Particularly, a computer program in the present disclosure may execute each of operations described above.

The computer-readable medium suitable for storing the computer program instructions and data, for example, a recording medium includes a magnetic medium such as a hard disk, a floppy disk, and a magnetic tape, an optical medium such as a compact disk read only memory (CD-ROM) and a digital video disk (DVD), a magneto-optical medium such as a floptical disk, and a semiconductor memory such as a read only memory (ROM), a random access memory (RAM), a flash memory, an erasable programmable ROM (EPROM), and an electrically erasable programmable ROM (EEPROM). A processor and a memory may be supplemented by or integrated into logic circuitry for a special purpose.

In addition, a computer-readable recording medium can also be distributed over network coupled computer systems so that a computer-readable code is stored and executed in a distributed fashion In addition, functional programs for implementing the present disclosure and codes and code segments related thereto may be easily construed or changed by programmers in the technical field to which the present disclosure belongs, by taking into consideration a system environment of a computer configured to execute a program by reading recording media.

In addition, a computer program recorded on the computer-readable recording medium as described above includes instructions that perform the functions described above, and is distributed and circulated through the recording medium, and is read by, and installed and executed on a particular device or a particular computer, thereby executing the functions described above.

Although the present disclosure has been described with reference to an embodiment illustrated in the drawings, this is only an example, and it will be understood by those of ordinary skill in the art that various changes in the form and details may be made therein without departing from the spirit and scope of the present disclosure as defined by the following claims.

### INDUSTRIAL APPLICABILITY

The present disclosure relates to a design of a safety critical system, and more particularly, to a computing apparatus having a multi-layered framework capable of providing guidance for a safety assurance process in designing a safety critical system based on machine learning, and a method of designing the safety critical system using the multi-layered framework.

The present disclosure may provide guidance for a safety assurance process capable of ensuring data quality through quantified uncertainty, belief, and plausibility, and facilitate development of tool support automated for supporting processes performed by stakeholders to contribute to advancement in artificial intelligence and safety critical system engineering industries, and thus, have sufficient industrial applicability.

### DESCRIPTION OF SYMBOLS

10: Problem Layer
11: Operational domain exploration module
12: Goals and requirements exploration module
13: Risk factor exploration module
20: Data Layer
21: Requirements derivation and analysis module
22: Requirements specification module
30: Evidence layer
31: Evidence enhancement module
32: Evidence integration module
100: Multi-layered framework

What is claimed is:

1. A multi-layered framework computing apparatus for designing a safety critical system using machine learning, the multi-layered framework computing apparatus comprising:
a memory and a processor;
a problem layer configured to produce a problem space exploration summary by defining an operational domain, safety critical goals and requirements, and risk factors for an operational environment to which the safety critical system is to be applied;
a data layer configured to produce a data requirements specification by defining data requirements using the problem space exploration summary to minimize data uncertainty factors; and
an evidence layer configured to produce a data uncertainty evaluation sheet corresponding to the data requirements using the problem space exploration summary and the data requirements specification.

2. The multi-layered framework computing apparatus of claim 1, wherein the problem layer comprises:
an operational domain exploration module configured to define the operational domain for the operational environment to which the safety critical system is to be applied;
a goals and requirements exploration module configured to define the safety critical goals, calculate operational requirements from the safety critical goals, and define domain components; and
a risk factor exploration module configured to produce the problem space exploration summary by defining the risk factors having risks and hazards with respect to a problem domain.

3. The multi-layered framework computing apparatus of claim 1, wherein the problem layer is configured to:
receive an input of at least one artifact among the safety requirements, scenarios, a safety critical goal model, an operational design domain (ODD), domain-specific concept taxonomy, risk and hazard factors, and safety critical factors, and
produce the problem space exploration summary including at least one item among basic safety requirements, relevant ODD factors, machine learning (ML) task-specific domain-concept definition, system-level risks associated with the safety critical goals, and domain-specific risk factors.

4. The multi-layered framework computing apparatus of claim 1, wherein the data uncertainty factors comprises:
a risk factor comprising at least one among a data collection error, a data preparation error, a representation gap, and an insufficient protection element against data corruption and capable of reducing reliability in training data; and
an insufficient mitigation plan element for domain-specific risks comprising at least one of demographic bias information and operational environment-related risk information.

5. The multi-layered framework computing apparatus of claim 1, wherein the data layer comprises:
a requirements derivation and analysis module configured to decompose the safety critical goals into sub-goals using the problem space exploration summary to minimize the data uncertainty factors, and define and produce the data requirements according to the sub-goals; and
a requirements specification module configured to produce the data requirements specification by defining an evidence and an acceptance criteria for the data requirements produced according to a predefined template and specifying a trace link for linking to the problem layer.

6. The multi-layered framework computing apparatus of claim 5, wherein the predefined template comprises at least one indicator among a data requirement type, a data requirement identification (ID), a data requirement description, the evidence, the acceptance criteria, and the trace link.

7. The multi-layered framework computing apparatus of claim 1, wherein the data layer is configured to:
further receive an input of at least one artifact among the problem space exploration summary, data-type specific quality criteria, machine learning (ML) model-specific data quantity criteria, data type-specific risk factors, and domain-specific risk factors, and
produce the data requirements specification comprising at least one item among data collection requirements, data annotation requirements, data representativeness requirements, trace links, and acceptable evidence to verify satisfaction of requirements.

8. The multi-layered framework computing apparatus of claim 1, wherein the evidence layer comprises:
an evidence enhancement module configured to collect evidence input in correspondence with the data requirements using the problem space exploration summary and the data requirements specification, and label the evidence collected; and
an evidence integration module configured to produce the data uncertainty evaluation sheet by calculating a belief mass for the evidence labeled safe or unsafe according to an evidence theory to produce the data uncertainty evaluation sheet.

9. The multi-layered framework computing apparatus of claim 8, wherein the evidence layer is configured to:
further receive an input of the problem space exploration summary and the data requirements specification, and an exploratory data analysis (EDA) summary; and
produce the data uncertainty evaluation sheet comprising at least one item among the data requirements, the evidence and arguments evaluated according to the belief mass, traceability, an uncertainty interval, and belief and plausibility.

10. A method of designing a safety critical system using a multi-layered framework computing apparatus configured to design the safety critical system using machine learning, the method comprising:
producing, by a processor and a memory, a problem space exploration summary by defining an operational domain, safety critical goals and requirements, and risk factors for an operational environment to which the safety critical system is to be applied;
producing, by the processor and the memory, a data requirements specification by defining data requirements using the problem space exploration summary to minimize data uncertainty factors; and
producing, by the processor and the memory, a data uncertainty evaluation sheet corresponding to the data requirements using the problem space exploration summary and the data requirements specification.

11. The method of claim 10, wherein the producing of the problem space exploration summary comprises:
defining the operational domain for the operational environment to which the safety critical system is to be applied;
defining the safety critical goals, calculating operational requirements from the safety critical goals, and defining domain components; and
producing the problem space exploration summary by defining risk factors having risks and hazards with respect to a problem domain.

12. The method of claim 10, wherein the producing of the data requirements specification comprises:
decomposing the safety critical goals into sub-goals using the problem space exploration summary to minimize the data uncertainty factors, and defining and producing the data requirements according to the sub-goals; and
producing the data requirements specification by defining an evidence and an acceptance criteria for the data requirements produced according to a predefined template and specifying a trace link for linking to a problem layer.

13. The method of claim 10, wherein the producing of the data uncertainty evaluation sheet comprises:
collecting evidence input in correspondence with the data requirements using the problem space exploration summary and the data requirements specification, and labeling the evidence collected; and
producing the data uncertainty evaluation sheet by calculating a belief mass for the evidence labeled safe or unsafe according to an evidence theory to produce the data uncertainty evaluation sheet.

14. A non-transitory computer-readable recording medium having recorded thereon a program for executing the method of designing a safety critical system using a multi-layered framework computing apparatus configured to design the safety critical system using machine learning, the method comprising:
producing, by a processor and a memory, a problem space exploration summary by defining an operational domain, safety critical goals and requirements, and risk factors for an operational environment to which the safety critical system is to be applied;
producing, by the processor and the memory, a data requirements specification by defining data requirements using the problem space exploration summary to minimize data uncertainty factors; and
producing, by the processor and the memory, a data uncertainty evaluation sheet corresponding to the data requirements using the problem space exploration summary and the data requirements specification.

15. The non-transitory computer-readable recording medium of claim 14, wherein the producing of the problem space exploration summary comprises:
defining the operational domain for the operational environment to which the safety critical system is to be applied;
defining the safety critical goals, calculating operational requirements from the safety critical goals, and defining domain components; and
producing the problem space exploration summary by defining risk factors having risks and hazards with respect to a problem domain.

16. The non-transitory computer-readable recording medium of claim 14, wherein the producing of the data requirements specification comprises:
decomposing the safety critical goals into sub-goals using the problem space exploration summary to minimize the data uncertainty factors, and defining and producing the data requirements according to the sub-goals; and
producing the data requirements specification by defining an evidence and an acceptance criteria for the data requirements produced according to a predefined template and specifying a trace link for linking to a problem layer.

17. The non-transitory computer-readable recording medium of claim 14, wherein the producing of the data uncertainty evaluation sheet comprises:
collecting evidence input in correspondence with the data requirements using the problem space exploration summary and the data requirements specification, and labeling the evidence collected; and
producing the data uncertainty evaluation sheet by calculating a belief mass for the evidence labeled safe or unsafe according to an evidence theory to produce the data uncertainty evaluation sheet.
